(19) United States
(12) Patent Application Publication
(10) Pub. No.: US 2015/0185104 A1
(43) Pub. Date: Jul. 2, 2015

(54) System for Calibrating a Tribometer Test Foot

(71) Applicant: George P. Widas, III, Greer, SC (US)

(72) Inventor: George P. Widas, III, Greer, SC (US)

(21) Appl. No.: 14/146,108

(22) Filed: Jan. 2, 2014

(51) Int. Cl. G01L 25/00

(52) U.S. Cl. CPC G01L 25/00

(57) ABSTRACT

A system for the calibration of a tribometer test foot utilizes a uniquely designed sanding pad with a hard-back sandpaper surface, and a separate, independent sander member which has a top section with a test foot mounting element in the form of a piston having a threaded connection for securing the test foot. The sander member, with test foot attached, is configured to mate with the sanding pad to allow the test foot to be sanded to the required calibration. Calibration of the test foot is accomplished by pressing the sander member onto the sanding pad such that the test foot is compelled against the sandpaper surface of the sanding pad and rotating the sander member for the requisite sanding and thus accurate calibration of the test foot.

### FIELD OF THE INVENTION

The present invention relates to tribometers for testing the slip resistance of various surfaces. More particularly, the present invention relates to improvements in accurately calibrating the test foot of a portable variable incidence tribometer, which measures the slip resistance of wet or oily, as well as dry surfaces, approximating the forces present during the walking process.

### BACKGROUND OF THE INVENTION

A tribometer is a device used for measuring surface friction. Tribometric devices utilize various methods for determining the frictional force present when one surface is pulled or pushed across another under a predetermined pressure. These devices fall within three generally recognized categories: (1) dragsled, (2) articulated strut, and (3) pendulum type testers. There are numerous tribometric devices in each category which test the frictional threes between different dry surfaces.

Various attempts have been made to provide devices which can reliably test the slip resistance on different surfaces, including wet surfaces. The most notable and successful of these is disclosed in U.S. Pat. No. 5,259,236, a tribometer which approximately duplicates the forces exerted on a test surface by a human foot or cane during the walking process. In this device, currently being sold as the English XL™ VIT tribometer, the force exerted on the test surface by a test specimen is provided by a fluid actuated cylinder supplied with a compressed fluid. This force is applied during a sufficiently short period of time so as to avoid the absorption and squeegee effects normally encountered when testing wet surfaces. The coefficient of friction for the test surface is then determined by measuring the angle of incidence at which the test specimen will slip when brought into contact with the test surface.

To ensure the accuracy of the results of tribometers shown in and similar to the device in the '236 patent, the calibration of each of the devices' test foot must be precise, in order to satisfy current ASTM F2508 standards for validating, calibrating, and certifying walkway tribometers. These requirements substantially reduce the permissible variations in test foot preparation. The values formerly assigned to calibration tiles were based on a much wider tolerance for test foot preparation. What was, and still is, more than sufficient to properly assess the accurate risk for a human slip and fall injury events is no longer enough to reliably comply with the F2508 criteria, the object of which is to assess the real world risk for a slip and fall injury event.

### SUMMARY OF THE INVENTION

The present invention provides a standardized test foot preparation device which makes it easy for users to achieve the required precision to comply with F2508. Henceforth, calibration tiles will have an assigned value based on the test foot calibration provided by the present invention. A user would not need not utilize the present invention if he or she could consistently produce reliable test foot preparation results on the certified calibration tile.

The test foot calibration device of the present invention was developed to consistently produce the 0.20 (±0.03) wet on the English XL™ calibration tile. This value has been the calibration value used in the many round-robins and research papers that have repeatedly proven the efficacy of the English XL™. It is important to also consider that the shape of a test foot prepared with the present invention (or by hand the same as the invention) is not perfectly flat, which mimics the characteristics of the worn heal contact area observed in analysis of footwear from actual, real world, slip and fall injury events.

These and other objectives of the invention are accomplished by a system for calibrating a tribometer test foot which comprises a uniquely designed sanding pad with a hard-back sandpaper surface, and a separate, independent sander member which has a top section with a test foot mounting element in the form of a piston having a threaded connection for securing the test foot. The sander member, with test foot attached, is configured to mate with the sanding pad to allow the test foot to be sanded to the required calibration.

The novel features which are considered as characteristic of the invention are set forth in particular in the appended claims. The invention, itself, however, both as to its design, construction and use, together with additional features and advantages thereof, are best understood upon review of the following detailed description with reference to the accompanying drawings.

### BRIEF DESCRIPTION OF THE DRAWINGS

FIG. 1 is an exploded perspective view of the components of the present invention with the test foot in position for calibration.

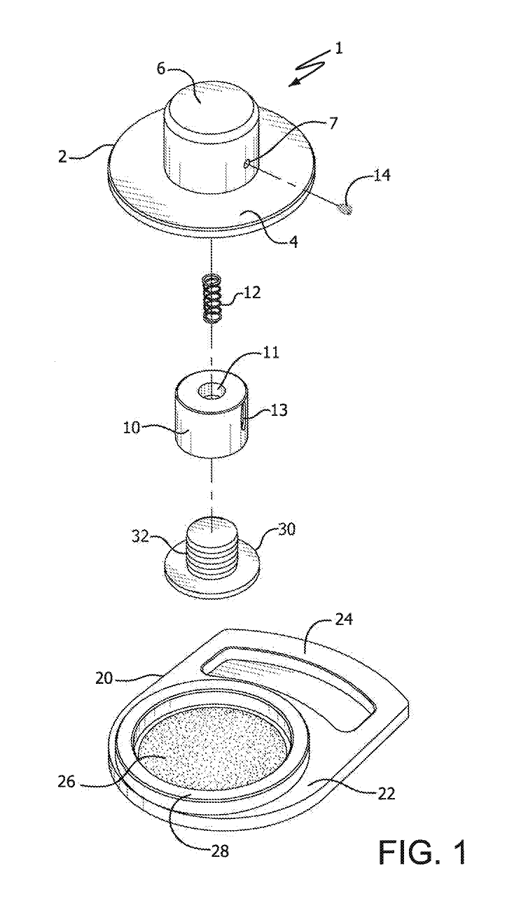

FIG. 2 is an exploded, cross-sectional view of the sander member with the test foot attached, and the sanding pad.

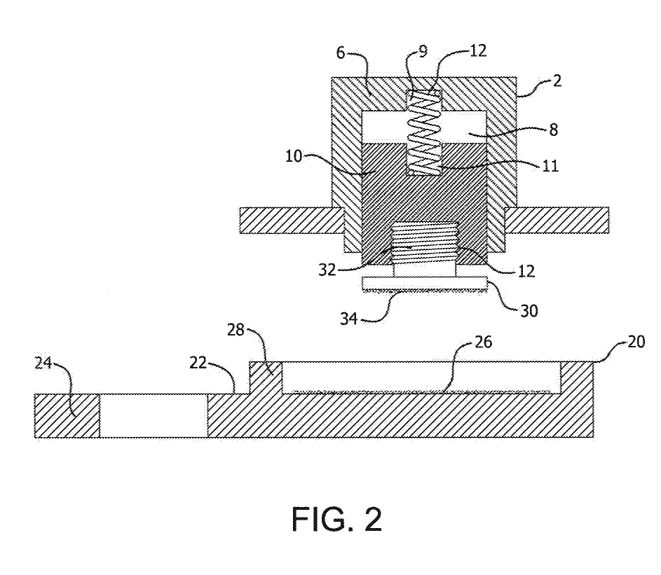

FIG. 3 depicts the manner of operation of the components of the present invention.

### DETAILED DESCRIPTION OF THE INVENTION

System 1 for calibrating a tribometer test foot comprises sander member 2 having base section 4 and top section 6 upstanding from the base section. Top section 6 has an open cavity 8 in which piston element 10 is located. A test foot connection means in the form of threaded test foot connection 12 is provided at the lower end of a test foot mounting element in the form of piston element 10. The piston element comprises vertical slot 13 aligned with tapped opening 7 through top section 6 of sander member 2. Tapping screw 14 extends through and is secured within opening 7 and into slot 13 in order to maintain piston element 10 in position within top section 6, so as to allow the piston to move vertically, i.e. up and down, within cavity 8 of the top section.

Spring 12 is positioned in cavity 8. The spring rests within indented space 11 of piston element 10 and extends into indent space 9 of top section 6 of sander member 2. Spring 12 is designed to biasedly maintain piston element 10 in position within cavity 8 of top section 6, while still allowing it to be compelled vertically into the cavity of the top section, against the biased force of the spring.

System 1 also comprises sanding pad 20 having platform base 22 with outwardly extending handle 24. Located on platform base 22 is course, 180 grit hard-back sandpaper or its equivalent type surface 26, circumscribed by rim 28 upstanding from the base.

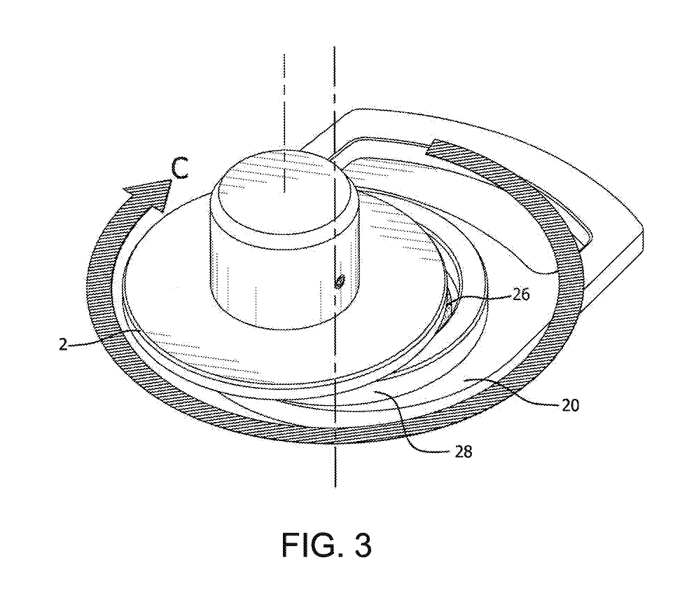

The basic operation of system 1 of the invention is as follows. Test foot 30, with its threaded connection 32, is removed from the tribometer, e.g. the English XL™ VET unit, and screwed, hand tight, into threaded connection 12 of sander member 2. Sander member 2 is then placed on rim 28 of sanding pad 20, such that the test foot is flush against sandpaper surface 26. See FIG. 3.

Sander member 2 is next lightly pressed on rim 28 and is rotated in clockwise circles C, continuing to maintain full contact between the base and the rim. As sander member 2 is rotated, spring 12 compels test foot 30, and particularly its bottom surface 34, against sandpaper surface 26, ensuring for the requisite sanding and thus accurate calibration of the test foot.

The test foot sanding process differs somewhat when the system is used with a test foot for the first time versus for subsequent sanding. However, the basic utilization of the test foot on sander member 2 in conjunction with sanding pad 20 remains the same, i.e. test foot 30 is attached to the sander member and is rotated on sandpaper surface 26 for the proper calibration.

After the sanding operation is completed, sander member 2, with test foot 30 still connected, is lifted off sanding pad 20. A dust brush, not the user's fingers, is used to clean the dust from the face of test foot 30. Properly calibrated test foot 30 is unthreaded and removed from sander member 2 and reinstalled on the tribometer, ready for use.

Certain novel features and components of this invention are disclosed in detail in order to make the invention clear in at least one form thereof. However, it is to be clearly understood that the invention as disclosed is not necessarily limited to the exact form and details as disclosed, since it is apparent that various modifications and changes may be made without departing from the spirit of the invention.

1. A system for calibrating a tribometer test foot comprising:
a sanding pad comprising a platform base and a course sandpaper-like surface circumscribed by a rim upstanding from the platform base; and
a separate, independent sander member having a base section of a given diameter and a top section upstanding from and having a smaller diameter than the base section, said top section enclosing a test foot mounting element and a spring maintaining the mounting element in a biased position within the top section, the test foot element having connection means for securing a test foot to the sander member.

2. The system as in claim 1 further comprising a handle extending from the platform base of the sanding pad.

3. The system as in claim 1 wherein the sander member is configured to be placed on the rim of the base of the sanding pad, such that the test foot is secured to the sander member and the bottom surface of the test foot is flush on the sandpaper-like surface of the sanding pad compelled by the spring against the sandpaper-like surface, whereby rotation of the sander member in relation to the sanding pad calibrates the test foot.

4. The system as in claim 1 wherein the mounting element is a piston configured for vertical movement within said top section.
